(19) United States
(12) Patent Application Publication
(10) Pub. No.: US 2015/0178390 A1
(43) Pub. Date: Jun. 25, 2015

(54) NATURAL LANGUAGE SEARCH ENGINE USING LEXICAL FUNCTIONS AND MEANING-TEXT CRITERIA

(71) Applicant: Jordi Torras, Sunnyvale, CA (US)

(72) Inventor: Jordi Torras, Sunnyvale, CA (US)

(21) Appl. No.: 14/577,554

(22) Filed: Dec. 19, 2014

Related U.S. Application Data
(60) Provisional application No. 61/919,279, filed on Dec. 20, 2013.

(51) Int. Cl. G06F 17/30

(52) U.S. Cl. CPC G06F 17/30864; G06F 17/30684

(57) ABSTRACT

Engines, systems, and methods for performing a natural language search are disclosed. The method may include receiving, via a user interface including a virtual assistant, at least one search query. The at least one search query may be converted into at least one first global semantic representation. The contents may be searched and for at least one second global semantic representation that matches the at least one first global semantic representation.

### CROSS-REFERENCE TO RELATED APPLICATION

This application claims priority to U.S. Provisional Application Ser. No. 61,919,279, filed Dec. 20, 2013, entitled “Natural Language Search Engine Using Lexical Functions and Meaning-Text Criteria,” which is incorporated herein by reference as if set forth in its entirety

### FIELD OF THE INVENTION

The present invention relates generally to search engines, and more particularly to natural language search engines using lexical functions and meaning-text criteria.

### BACKGROUND OF THE INVENTION

Search engines use automated software programs so-called “spiders” to survey documents and build their databases. Documents are retrieved by these programs and analyzed. Data collected from each document are then added to the search engine index. When a user query is entered at a search engine site, the input is checked against the search engine's index of all documents it has analyzed. The best documents are then returned as hits, ranked in order with the best results at the top.

Existing Natural Language searching software bases its analysis on the retrieval of “keywords”, the syntactic structure of the phrases, and the formal distribution of words in a particular phrase, to the detriment of semantics. These bases, unfortunately, do not allow for understanding and recognizing the meaning of a user's query. As such, a need exists for a system and method for effective recognition for retrieving actual and meaningful information from searches.

### SUMMARY OF THE INVENTION

Engines, systems, and methods for performing a natural language search are disclosed. The method may include receiving, via a user interface including a virtual assistant, at least one search query. The at least one search query may be converted into at least one first global semantic representation. The contents may be searched and for at least one second global semantic representation that matches the at least one first global semantic representation.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 is a block diagram of a search engine according to embodiments of the present disclosure;

FIG. 2 is a representation of an entry or register of the dictionary and lexical functions database 21 according to embodiments of the disclosure;

FIG. 3 illustrates a method for transforming a natural language query into a first global semantic representation.

FIG. 4 illustrates a method for transforming the contents into a second global semantic representation; and

FIG. 5 illustrates a method for the indexing of the at least one second semantic representation of the at least one second global semantic representation of the contents of a database according to embodiments of the present disclosure; and

FIG. 6 is an illustration of the scored coincidence algorithm for matching the at least one first global semantic representation and the at least one second global semantic representation according to embodiments of the present disclosure.

### DETAILED DESCRIPTION OF THE EMBODIMENTS

It is to be understood that the figures and descriptions of the present invention have been simplified to illustrate elements that are relevant for a clear understanding of the present invention, while eliminating, for the purpose of clarity, many other elements found in typical search engines, systems, and processes. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

There are two primary methods of text searching: keyword searching and natural language searching. Keyword searching is the most common way of text search. Most search engines do their text query and retrieval using keywords. This method achieves a very fast search, even with large amounts of data behind to search for and a fully automatic and autonomous indexing is made possible. However, the fact that the search is based on forms (strings of characters) and not concepts or linguistic structures limits the effectiveness of the searches. One of the problems with keyword searching, for instance, is that it is difficult to specify the field or the subject of the search because the context of searched keywords is not taken into account. For example, they may not be able to distinguish between polysemous words (i.e. words that are spelled the same way, but have a different meaning)

Most keyword search engines cannot return hits on keywords that mean the same, but are not actually entered in the user's query. A query on heart disease, for instance, would not return a document that used the word “cardiac” instead of “heart”. Some search engines based on keywords use thesaurus or other linguistic resources to expand the number of forms to be searched, but the fact that this expansion is made keyword by keyword expansion, regardless of the context, causes combinations of keywords that completely change the original intention of the query. For example, from ‘Heart+disease’ the user could reach ‘core+virus” and completely miss the topic of the search and get unrelated results.

Some search engines also have trouble with so-called stemming. For example, if a user entered the word “fun,” the system may be confused as to whether to return a hit on the word, “fund.” The system may have further difficulty or uncertainty as to whether to return singular and plural words, and different verb tenses.

Unlike keyword search systems, natural language-based search systems attempt to determine what a user means, and not just what a user says, by means of natural language processing. Both queries and document data are transformed into a predetermined linguistic (syntactic or semantic) structure. The resulting matching goes beyond finding similar shapes, and aims at finding similar core meanings.

These search engines transform samples of human language into more formal representations (usually as parse trees or first-order logic structures). To achieve this, many different resources that contain the required linguistic knowledge (lexical, morphological, syntactic, semantic . . . ) are used. The nerve center is usually a grammar (context-free, unrestricted, context sensitive, semantic grammar, etc. . . . ) which contains linguistic rules to create formal representations together with the knowledge found in the other resources.

Most natural language-based search engines do their text query and retrieval by using syntactic representations and their subsequent semantic interpretation. The intention to embrace all aspects of a language, and being able to syntactically represent the whole set of structures of a language using different types of linguistic knowledge makes this type of system extremely complex. Other search systems, among which the one of the present disclosure is included, choose to simplify this process, for example, by dismissing syntactic structure as the central part of the formal representation of the query. These streamlined processes are usually more effective, especially when indexing large amounts of data from documents. But since these systems synthesize less information than a full natural language processing system, they may also require refined matching algorithms to fill the resulting gap.

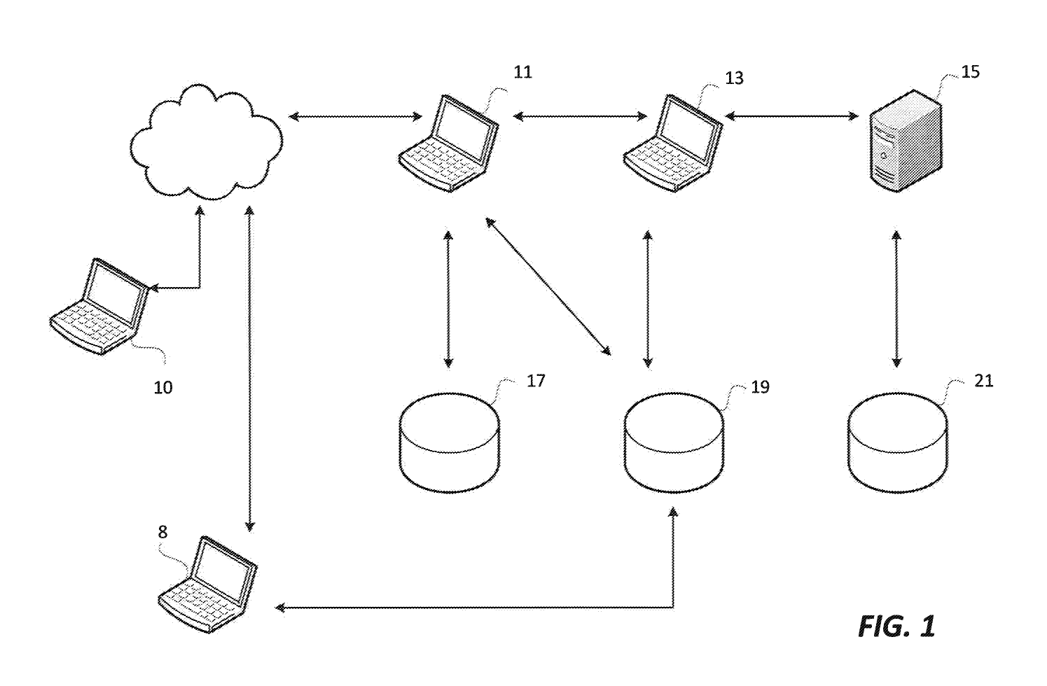

Embodiments of the present disclosure are directed to a natural language searching that employs lexical functions and meaning-text criteria which may result in more effective recognition and retrieval of desired information. FIG. 1 is a block diagram of a search engine according to embodiments of the present disclosure. As shown, a user 10 may perform a natural language query, for example, via the internet 1. The query may be passed to a content engine 11 connected to query engine 13, which communicates with a lexical function server 15. The content engine 11 includes a log database 17 that stores all activity on the system, and is connected to a contents database 19, which, in turn, is accessible by the query engine 13.

The query engine 13 passes the natural language query to the lexical function server 15, which may convert the natural language query into a first semantic representation that, when combined as a sequence, gives a first global semantic representation of its meaning Contents database 19 contains categorized formal responses as well as content knowledge used to match inputs with the contents. The contents of this database 19 may be indexed having a structure (e.g., sequences of pairs of lemmas L and semantic category SC forming LSC2 and becoming a second global semantic representation LSCS2) similar to that of the first global semantic representation LSCS1 of the original natural language query. More specifically, in the same manner as the natural language query is converted, the query engine 13 passes contents to the lexical function server 15, which converts these contents into second semantic representations that, when combined as a sequence give a second global semantic representation of its meaning. This second global semantic representation may be fed back to the query engine 13 and indexed in contents database 19. The query engine 13 may then obtain the best response for the natural language query based, at least in part, on the first and second global semantic representations, provided by the lexical function server 15.

In light of the foregoing, although it is not shown in FIG. 1, contents database 19 may be implemented in a file in a computer remote to the lexical functions server 15, and can be accessed, for example, through the internet or other wide area network (WAN), local area network (LAN), or the like. Further, the content engine 11 and query engine 13 may be implemented in separate respective computers, or in the same computer. Further still, these engines may both be implemented in the lexical functions server 15.

The lexical functions server 15 includes a dictionary and a lexical functions database 21 having multiple registers 23. Each of the registers 23 is composed of several fields having an entry word, a semantic category of the entry word, and a lemma of the entry word, which, when combined, represent the meaning of the word. Each of the multiple registers 100 also contains syntagmatic and paradigmatic lexical functions associated with the meaning of the word including synonyms (syn0; syn1; syn2, . . . ), contraries, superlatives, adjectives associated with the word, and verbs associated with the word.

As used herein, paradigmatic lexical functions are lexical functions used to associate, with a keyword, a set of lexical terms that share in a lexicon, a non-trivial component with the keyword. Also as used herein, syntagmatic lexical functions are lexical functions used to formalize a semantic relation between two lexemes L1 and L2, for example, which may be realized in a textual string in a non-predictable way.

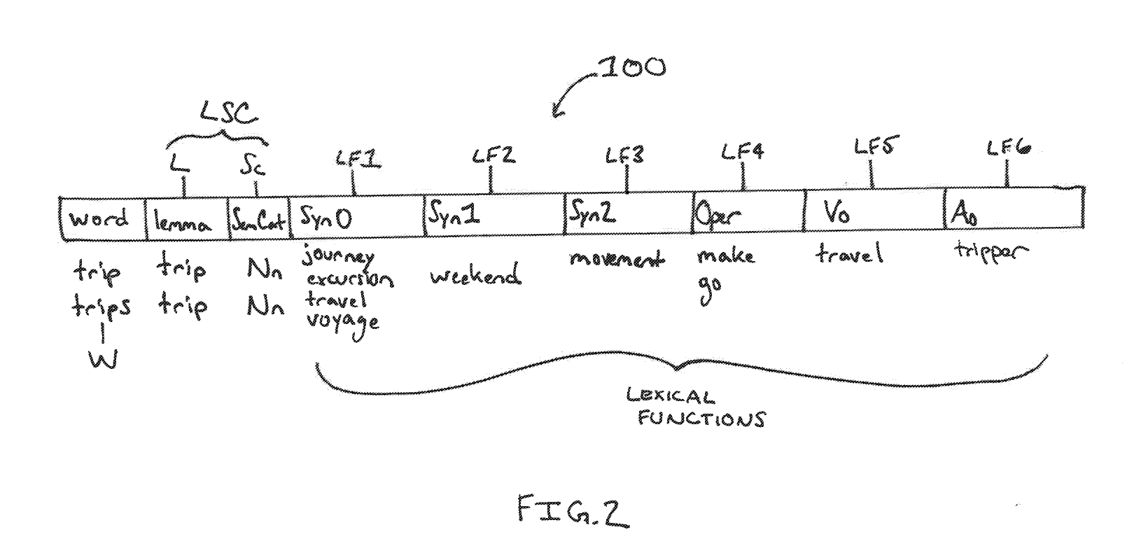

FIG. 2 is a representation of an entry or register of the dictionary and lexical functions database 21 according to embodiments of the disclosure, corresponding to the words “trip” (singular) and “trips” (plural). The entries are words W. In this example, the words have a common semantic representation LSC consisting of the same lemma L, being “trip”, representing both “trip” and “trips”, linked to the semantic category SC, which is, in this case, a normal noun (Nn). Following the semantic representation of the meaning of the word (lemma L and semantic category SC), are different lexical functions LF, such as synonyms LF1, LF2, and LF3, verbs LF4 and LF5 associated with the word, adjectives LF6 associated with the word, and the like. It should be noted that the dictionary and lexical functions database 21 may be updated at any time, such as, for example, sporadically, on a regular basis, or project to project.

In light of the foregoing, according to embodiments of the disclosure, the natural language search engine may return to a user a response as a result of a matching process. The matching process comprises transforming the natural language query into a first global semantic representation that gives a full meaning of the query; comparing the first global semantic representation with a second global semantic representation from the contents database 19, and selecting the response having contents having a best semantic matching degree.

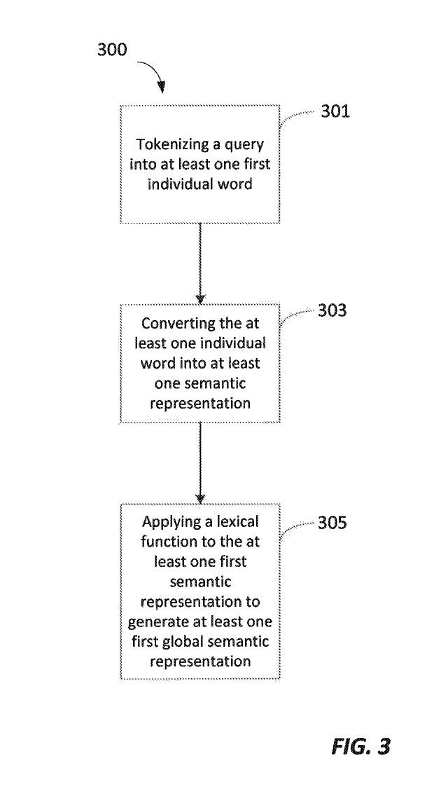

FIG. 3 illustrates a method 300 for transforming the natural language query into a first global semantic representation. Method 300 may include tokenizing the natural language query into at least one first individual word at step 301. At step 303, the at least one first individual word may be converted into at least one first semantic representation. The at least one first semantic representation includes at least one pair of lemma and a semantic category, which may be retrieved from the lexical functions database 21. At step 305, a lexical function may be applied to the at least one first semantic representation to generate at least one first global semantic representation of the natural language query.

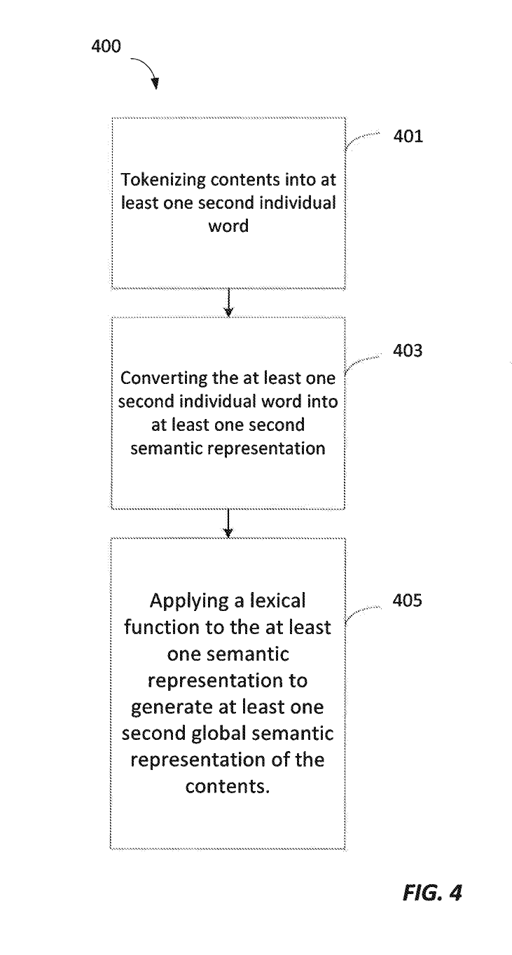

FIG. 4 illustrates a method 400 for transforming the contents into a second global semantic representation. Method 400 may include tokenizing the contents into at least one second individual word at step 401. At step 403, the at least one second individual word may be converted into at least one second semantic representation. The at least one second semantic representation includes at least one pair of lemma and a semantic category, which may be retrieved from the lexical functions database 21. At step 405, a lexical function may be applied to the at least one second semantic representation to generate at least one second global semantic representation of the contents.

The search engine may then calculate a semantic matching degree in a matching process, between the at least one first global semantic representation and the at least one second contents global semantic representation by assigning a score, and retrieving the contents which have the best matches (e.g., score) between the at least one first global semantic representation and the at least one second global semantic representation from the contents database 19. The process is repeated for all the contents in the contents database 21 to be analyzed, and the response is selected that has the best score, according to established criteria.

The natural language query may be converted “on the fly” and the contents may be converted and indexed on any regular basis or sporadically. As it will be understood, the semantic search engine of the present disclosure enhances the possibilities of semantics and of lexical combinations, on the basis of the work carried out by I. Melcuk, within the frame of the Meaning-Text theory (MTT). The semantic search engine of the present disclosure is based on the theoretical principle that languages are defined by the way their elements are combined. This new theory explains that it is the proper lexicon that imposes this combination and, therefore, stresses focus on the description of the lexical units and its semantics and not so much on a syntactic description.

Embodiments of the disclosure allow for the detection of phrases with the same meaning, even though they may be formally different. For example, according to embodiments, the natural language search engine is able to regroup any questions asked by a user, no matter how different or complex they may be, and find the appropriate information and response.

Indeed, lexical functions LF (LF1, . . . LF6, . . . ) are tools configured to formally represent relations between lexical units, wherein what is calculated is the contributed value and not the sum of the meaning of each element, since a sum might bring about an error in an automatic text analysis. The matching process is based on this principle not to sum up meanings but calculating contributed values to the whole meaning of the query and each of the contents (or each candidate to be a result).

Lexical Functions, therefore, allow for the formalization and description, in a relatively simple manner, the complex lexical relationship network that languages present and assign a corresponding semantic weight to each element in the phrase. Most importantly, however, they allow relation of analogous meanings regardless of the form in which they are presented.

Again referring to FIG. 2, “syn0” (lexical function LF1), “syn1” (lexical function LF2), “syn . . . n” for synonyms at a distance n (see FIG. 1); “cont” for contrary, and “super” for superlatives, are all examples of lexical functions. Lexical functions may be used to define semantic connections between elements and provide meaning expansion (synonyms, hyperonyms, hyponyms . . . ) or meaning transformation (merging sequences of elements into a unique meaning or assigning semantic weight to each element).

The afore-discussed matching process may be performed through a scored coincidence algorithm. The “content knowledge” of the content database 19 is to be understood as the sum of values from the contents C. The number, attributes, and functionalities of these contents C are predefined for every single project and they characterize the way in which the contents C will be indexed. Each piece of content C has two attributes related to the scoring process.

As used herein, a linguistic type may refer to data that the content C may contain and the way to calculate the coincidence between the query Q and the content C. As used herein, a reliability factor (from 1 to 0) may refer to a reliability of the nature of the matching for that content in particular.

Once the contents C are defined, they may be filled with natural language phrases or expressions to get a robust content knowledge. This process can be automatic (through the spider 8) or manual. The indexing of the contents C includes storing the linguistic type, the reliability factor and the at least one second global semantic representation (LSCS2) of its natural language phrases or expressions. The indexing of the at least one second semantic representation LSCS2 comprises a semantic weight calculated for each at least one second semantic representation in the query engine 13.

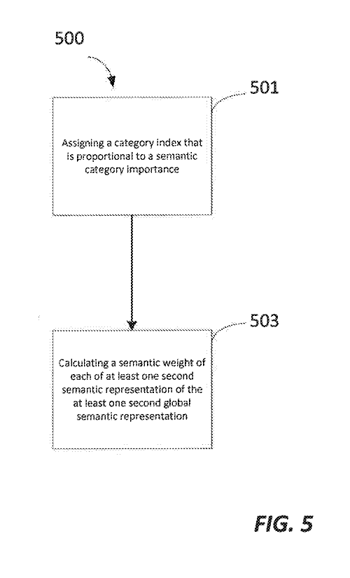

FIG. 5 illustrates a method 500 for the indexing of the at least one second semantic representation of the at least one second global semantic representation of the contents C. Step 501 may include assigning a category index (ICAT) that is proportional to a semantic category importance. Step 503 may include calculating a semantic weight (SWC2) of each at least one second semantic representation (LSC2) of the at least one second global semantic representation of the contents C (LSCS2), by dividing the assigned category index (ICAT) by the sum of category indexes of the at least one semantic representations (LSC2) of the at least one global semantic representation of the contents C (LSCS2).

Scored Coincidence Algorithm for Matching Process

A Scored Coincidence Algorithm may be used by the query engine 13 to find best matches between the input and the content knowledge in contents database 19. More specifically, the query engine 13 searches and calculates the semantic coincidence between the query Q and the contents C in order to get a list of scored matches. It subsequently values the similarity between these matches to get a list of completed scored matches.

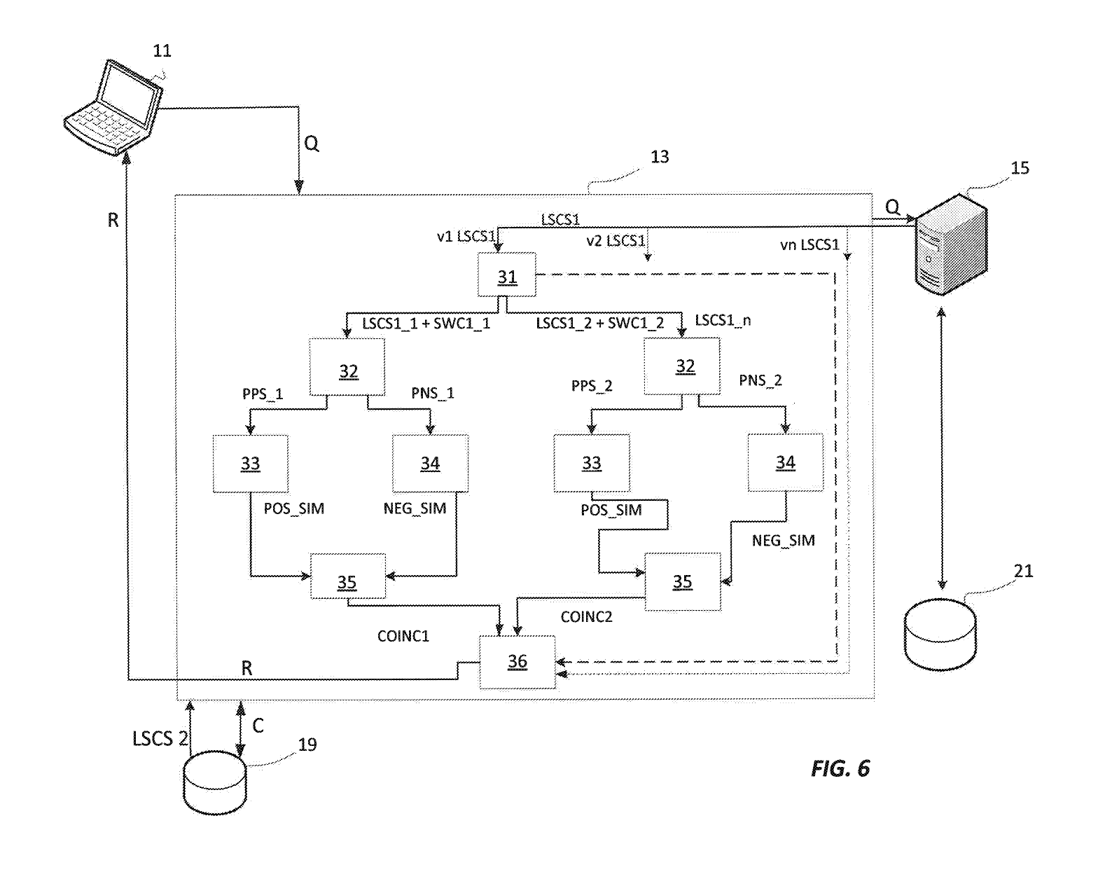

FIG. 6 is an illustration of the scored coincidence algorithm for matching the at least one first global semantic representation and the at least one second global semantic representation. For each at least one first semantic representation of the at least one first global semantic representation (LSCS1) of the natural language query Q, a category index (ICAT) is assigned, which is proportional to semantic category (SC) importance. At block 31, a calculation of a semantic weight (SWC1) of the at least one first semantic representation (LSC1) of the at least one first global semantic representation (LSCS1) of the natural language query Q, by dividing its category index (ICAT) by the sum of category indexes of all at least one first semantic representations (LSC1) of the at least one first global semantic representation (LSCS1) of the natural language query Q.

The process as illustrated in FIG. 6, is run for each at least one first semantic representation (LSC1) of the at least one first global semantic representation (LSCS1) of the natural language query Q. For example, if the at least one first semantic representation (LSC1) matches at least one second semantic representation (LSC2) of the at least one second global semantic representation (LSCS2) of the contents C or a lexical function (LF1, LF2, LF3, . . . ) of the at least one second semantic representation (LSC2) of the at least one second global semantic representation (LSCS2) of the contents C, in a register 100 of the dictionary, then, in block 32, a partial positive similarity as PPS=SWC1×SAF is calculated.

As used herein, SAF may be defined as a Semantic Approximation Factor varying between 0 and 1 which accounts for the semantic distance between the at least one first semantic representation (LSC1) and the matched at least one second semantic representation (LSC2) or lexical function of the at least one second semantic representation (LSC2). SAF may represent the difference between matching the same meaning (LSC1=LSC2 where SAF=1) or matching a lexical function of the meaning (LSC1=LSC2's Lexical Function LFn where SAF=factor attached to the Lexical Function type).

In FIG. 6, two PPS outputs from block 31 are shown (PPS1 and PPS2). If the at least one first semantic representation (LSC1) doesn't match any of the at least one second semantic representations (LSC2) of the at least one second global semantic representation of the contents C (LSCS2), or a lexical function (LF1, LF2. LF3, . . . ) of the at least one second semantic representation (LSC2) of the at least one second global semantic representations of the contents C (LSCS2) then the partial positive similarity PPS is equal to 0.

In block 33, a Total Positive Similarity (POS_SIM) is calculated as the sum of all the aforesaid partial positives similarities (PPS) of the global semantic representation (LSCS1) of the query (Q). Subsequently, for every semantic representation (LSC2) of the at least one second global semantic representation (LSCS2) of the contents C that did not contribute to the total Positive Similarity (POS_SIM), then a partial negative similarity is calculated as PNS=semantic weight (SWC2) of the LSC2 with no correspondence in LSCS1.

A Total Negative Similarity (NEG_SIM) is calculated in block 34 as the sum of all the aforesaid partial negative similarities (PNS) of the global semantic representation (LSCS2) of the contents (C). In block 35, a semantic coincidence score (COING1; COINC2) is calculated in a way that depends on the linguistic type of the content (C). In the case when the linguistic type equals the phrase, a semantic coincidence score (COINS1; COINC2) is calculated as the difference between the Total Positive Similarity (POS_SIM) and Total Negative Similarity (NEG_SIM). In the case when the linguistic type equals freetext, a semantic coincidence score (COINC1; COINC2) is calculated by taking the same value than the Total Positive Similarity (POS_SIM).

In block 36, the semantic matching degree between the query Q and a content C is calculated for each coincidence (COINC1: COINC2) between the at least one first global semantic representation of the query Q (LSCS1) and the at least one second global semantic representation of the content C (LSCS2), as the coincidence (COINC1; COINC2) for the reliability factor (reliability of the matching) of content C. It should be noted that, in block 36, other decision making processes can be performed.

The response (R) to the query (Q) may be selected as the contents (C) having the higher semantic matching degree, response (R) is outputted from query engine 13 to content engine 11, as it is shown in FIG. 1. As it can be seen, the score of the semantic matching degree of each match may be represented by a number between 0 (no coincidence found between query and content knowledge) and 1 (perfect match between query and content knowledge). All the scores within this range show an objective proportion of fitting between the query and the content.

The way in which this objectiveness is embodied into the final output varies depending on the projects. Each project has its expectation level: which quality should the results have and how many of them should be part of the output. This desirable expected output can be shaped by applying “static settings” on the query engine 13 and the “maximum number of results” on the content engine 11.

Embodiments of the present disclosure may include a component configured to enable users to conduct a natural language query via a virtual assistant. The virtual assistant may serve as an alternative to a human call center agent. For example, a user, connected to the Internet, wireless network, and the like, can perform various natural language searches which may take the form of a voice/audio search, video search, and/or a conventional text search. With respect to a text search, for example, the user can insert one or more text queries into a text field.

The virtual assistant tool may provide a user with a natural communication environment to help the user obtain the most appropriate search results for his one or more natural language search queries. For example, the virtual assistant may ask the user one or more questions to better understand the user's natural language query. In operation, the virtual assistant may be incorporated into an online travel agency, for example. The virtual assistant may ask the user for a destination. The user may reply with “Nice” for example. The virtual assistant may then inquire as to the origin of the trip. The user may enter “Barcelona”.

The virtual assistant may then confirm the trip details through inquiring “You want to travel from Barcelona to Rome?” Through the afore-discussed embodiments (e.g., search engine techniques using natural language and the meaning text theory), the virtual assistant may be able to distinguish between the adjective “nice”, and the city of “Nice”. Upon confirmation from the user, the virtual assistant may prompt the incorporated system, engine, or website (e.g., travel agency website) to search for flights, hotels, and the like, associated with a trip from Barcelona to Rome.

Separate or in conjunction with the afore-discussed virtual assistant, embodiments of the present disclosure may include dynamic frequently asked questions (“FAQ”) which may be include an exhaustive knowledge database to address concerns and questions of users. By incorporating the afore-discussed natural language search engine techniques, dynamic FAQs may be configured to interpret questions of users, regardless of the form (e.g., sentences or keywords) in which the questions are asked, and give relevant responses.

As such, through repeatedly responding to user queries, embodiments of the present disclosure are able to continually learn, and update a database of FAQs to proactively address concerns and questions of users. Accordingly, dynamic FAQs are able to address questions that can be directly solved with a standard answer. These types of questions generally make up over 80% of questions asked in customer service centers by e-mail or telephone. By having standard answers immediately available to address most questions, business resources are freed up to focus on other tasks. When offering an instant and relevant response to a search, doubt, fear, or even to a need expressed by users, dynamic FAQs may improve conversion and retention rates of a website.

Embodiments of the present disclosure may work in conjunction with the Google Search Appliance™ to allow for more effective retrieval of accurate and appropriate information in accordance with a query. For example, embodiments include a connector configured to enable indexing and query-time connections between the Google Search Appliance™ and a repository. The connector may employ the afore-discussed search engine natural language and meaning text theory techniques to traverse afore-discussed databases and feed document data to the Google Search Appliance™ for indexing.

Certain embodiments of the present disclosure are directed to social media monitoring. Due to the ubiquitous nature of Web 2.0 media, web users have become active players and can create, organize, and broadcast content of their own. Consequently, it may be advantageous to harness this content by monitoring the sources of this content and other associated information including hundreds of thousands of comments and posts. Employing the natural language technology as discussed herein, and, particularly, employing semantic clustering techniques, embodiments are able to extract vast amounts of comments from the Internet and other large networks, group them by their meaning, and create groups of comments that are similar in meaning called “semantic clusters.” These semantic clusters can be particularly useful as they may be indicative of an entity's metrics, such as quality of customer service, performance of an entity's delivery system, price of an entity's products, or feedback on an entity's communication campaigns.

This semantic social media monitoring may analyze, on any regular basis (e.g., daily, weekly, and the like), and trigger an alert to the user. This alert may also include provided the user with statistics on an evolution of a particular semantic cluster over time, the volume and the sentiment (positive, neutral, negative, or the like) on different sources.

Further, and in conjunction with the afore-discussed social media monitoring services, certain embodiments may include a social media management system that may allow companies to manage large volumes of customer messages coming from social media by employing natural language processing technologies as discussed herein, and using predefined responses. For example, the system may effectively analyze and process messages coming from social networks, such as Twitter™, Facebook™, forms consumer websites, and the like. Using semantic parsing of the content of the messages, embodiments are able to automatically route messages to appropriate service or agent, to address or the message, and/or recommend a canned response to an appropriate customer service agent in an effort to save the agent time. As such, over time, an exhaustive database of canned responses can be created to capitalize on the agent's editorial work and identify main customer queries.

Embodiments of the present disclosure also include semantic search engine optimization tools. These tools can be used to attain more effective positions on a results page of various search engines. Using the afore-discussed natural language search engine techniques, the tools allow the creation of content based on actual user questions and vocabulary, using different wordings that real users may have entered. This content may later be crawled by popular search engines, and this content may bring visitors to sites incorporating the tool that would not have otherwise visited the site.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention as set forth in the claims hereinafter.

1. A method for retrieving contents from a database in response to a natural language search, the method comprising:
receiving, via a user interface including a virtual assistant, at least one search query;
converting the at least one search query into at least one first global semantic representation; and
searching within the contents for at least one second global semantic representation that matches the at least one first global semantic representation.

2. The method of claim 1, wherein the converting the at least one search query comprises:
tokenizing the at least one search query into at least one word;
transforming the at least one word into a plurality of first semantic representations; and
applying at least one lexical function to the plurality of first semantic representations.

3. The method of claim 1, wherein the at least one second global semantic representation is created by:
tokenizing the contents into at least one second individual word;
transforming the at least one second individual word into a plurality of second semantic representations; and
applying lexical functions to the plurality of second semantic representations.
